(19) United States
(12) Patent Application Publication
(10) Pub. No.: US 2010/0008202 A1
(43) Pub. Date: Jan. 14, 2010

(54) OPTICAL INFORMATION RECORDING MEDIUM, RECORDING PARTICLE, METHOD FOR REPRODUCING OPTICAL INFORMATION, OPTICAL INFORMATION REPRODUCING APPARATUS, METHOD FOR RECORDING OPTICAL INFORMATION, AND OPTICAL INFORMATION RECORDING APPARATUS

(75) Inventor: Naoto Kojima, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/500,406

(22) Filed: Jul. 9, 2009

(30) Foreign Application Priority Data
Jul. 11, 2008 (JP) P2008-181604

(51) Int. Cl. G11B 7/20; G11B 7/00

(52) U.S. Cl. 369/94; 369/100; G9B/7

(57) ABSTRACT

An optical information recording apparatus includes a recording layer, wherein nanoparticles having diameters of 100 nm or less are disposed while being surrounded by a medium having a complex dielectric constant which is changed in accordance with an application of light and the degree of local plasmon resonance produced by the nanoparticles is changed in accordance with the change in the complex dielectric constant of the medium.

### CROSS REFERENCES TO RELATED APPLICATIONS

The present application claims priority to Japanese Priority Patent Application JP 2008-181604 filed in the Japan Patent Office on Jul. 11, 2008, the entire content of which is hereby incorporated by reference.

### BACKGROUND

The present application relates to an optical information recording medium, a recording particle, a method for reproducing optical information, an optical information reproducing apparatus, a method for recoding optical information, and an optical information recording apparatus. For example, the present application is favorably applied to an optical information recording medium having a large storage capacity.

Previously, optical information recording and reproducing apparatuses, in which information is recorded on optical disks serving as optical information recording media by applying light beams to the optical disks and the information is reproduced from the optical disks, have come into widespread use. As for the optical disks, in general, Compact Disc (CD), Digital Versatile Disc (DVD), Blue-ray Disc (registered trade mark, hereafter referred to as BD), and the like have been used.

In the optical disk device, various types of information, such as various contents, e.g., music contents and image contents, and various data for computers, is recorded on optical disks. Particularly in recent years, the amount of information has increased along with higher definition images, higher sound quality music, and the like, and an increase in the number of contents recorded on one optical disk has been necessary. Therefore, an increase in capacity of the optical disk has been necessary.

Regarding this optical disk device, the spot size of the light beam has been reduced by decreasing the wavelength of the light beam to be used and increasing the numerical aperture (NA) of an objective lens, and along with this, the size of a recording mark has been reduced, so that a higher capacity optical disk has been realized.

In general, it is believed that it is difficult to reduce the diameter of the spot size to less than a wavelength size of the light beam because of the diffraction limit of light. Therefore, a near field optical lens, e.g., a solid immersion lens, has been proposed, wherein a high refractive index material is used and the distance from an optical information recording medium is reduced to within one-quarter the wavelength λ (for example, refer to Japanese Unexamined Patent Application Publication No. 2005-182895).

However, even when this solid immersion lens is used, it is believed that 100 nm is the limit of reduction of the diameter of the spot size. Consequently, a method for forming a spot having a small spot size by a plasmon antenna which causes a plasmon resonance phenomenon locally has been proposed (for example, refer to T. Matsumoto, T. Shimano, H. Saga, and H. Sukeda J. Appl. Phys., Vol. 95, No. 8, 15 Apr. 2004).

In this manner, the size of the recording mark on the optical information recording medium can be made fine, and it is expected that the optical information recording medium can have a higher capacity.

### SUMMARY

Incidentally, regarding an optical disk device having the above-described configuration, there is a problem in that the light returned from a recording mark is reduced as the recording mark is made finer.

The present application addresses the above-identified, and other problems associated with existing methods and apparatuses. It is desirable to provide an optical information recording medium capable of increasing the amount of returned light, an information recording particle used for the optical information recording medium, and a method for reproducing optical information, an optical information reproducing apparatus, a method for recoding optical information, and an optical information recording apparatus, in which the optical information recording medium is used.

According to an embodiment, an optical information recording apparatus includes a recording layer, wherein nanoparticles having diameters of 100 nm or less are disposed while being surrounded by a medium having a complex dielectric constant which is changed in accordance with an application of light and the degree of local plasmon resonance produced by the nanoparticles is changed in accordance with the change in the complex dielectric constant of the medium.

Consequently, regarding the optical information recording medium, scattered light, which is generated by the local plasmon resonance and which has high intensity, can be received as returned light.

An optical information recording medium according to an embodiment includes a recording layer, wherein metal fine particles having diameters of 100 nm or less are surrounded by a phase change material which shifts to a crystalline state or an amorphous state in accordance with the application of light.

Consequently, regarding the optical information recording medium, scattered light, which is generated by the local plasmon resonance and which has high intensity, can be received as returned light.

Furthermore, an optical information recording medium according to an embodiment includes a recording layer, which is formed from nanoparticles having diameters of 100 nm or less and a medium, on which information is recorded by changing the complex dielectric constant of the medium in accordance with an application of recording light, and from which the information is reproduced on the basis of a change in degree of local plasmon resonance produced by the nanoparticles in accordance with an application of reading light.

Consequently, regarding the optical information recording medium, scattered light, which is generated by the local plasmon resonance and which has high intensity, can be received as returned light.

In a recording particle according to an embodiment, a nanoparticle having a diameter of 100 nm or less is enveloped in a medium having a complex dielectric constant which is changed in accordance with an application of light with a predetermined level of or higher intensity.

Consequently, regarding the recording particle, scattered light, which is generated by the local plasmon resonance and which has high intensity, can be received as returned light.

Furthermore, a recording particle according to an embodiment is formed from a nanoparticle having a diameter of 100 nm or less and a medium enveloping the nanoparticle, wherein the complex dielectric constant of any one of the recording particle and the medium is changed in accordance with an application of light with a predetermined level of or higher intensity.

Consequently, regarding the recording particle, scattered light, which is generated by the local plasmon resonance and which has high intensity, can be received as returned light.

Furthermore, in a method for reproducing optical information and an optical information reproducing apparatus according to an embodiment, light is condensed and applied to an optical information recording medium, and the degree of local plasmon resonance produced in the optical information recording medium is detected.

Consequently, regarding the method for reproducing optical information and the optical information reproducing apparatus, scattered light, which is generated by the local plasmon resonance and which has high intensity, can be received as returned light.

Furthermore, a method for recoding optical information according to an embodiment includes the step of recording information by changing the degree of local plasmon resonance produced in an optical information recording medium when light is applied to the optical information recording medium.

Consequently, regarding the method for recoding optical information, scattered light, which is generated by the local plasmon resonance in accordance with an application of reproducing light and which has high intensity, can be received as returned light.

Furthermore, an optical information recording apparatus according to an embodiment includes a light application portion, which condenses light emitted from a light source and applies the light to an optical information recording medium, and a light intensity control portion to change the intensity of the light in such a way as to change the degree of local plasmon resonance produced in the optical information recording medium.

Consequently, regarding the optical information recording apparatus, scattered light, which is generated by the local plasmon resonance in accordance with an application of reproducing light and which has high intensity, can be received as returned light.

According to an embodiment, scattered light, which is generated by the local plasmon resonance and which has high intensity, can be received as returned light and, thereby, the optical information recording medium capable of increasing the amount of returned light, the information recording particle used for the optical information recording medium, and the method for reproducing optical information, the optical information reproducing apparatus, the method for recoding optical information, and the optical information recording apparatus, in which the optical information recording medium is used, can be realized.

Additional features and advantages are described in, and will be apparent from, the following Detailed Description and the figures.

### BRIEF DESCRIPTION OF THE FIGURES

FIG. 1 is a schematic diagram showing the relationship between the refractive index and the polarization of each material;

FIGS. 2A to 2C are schematic diagrams for explaining a recording principle according to an embodiment;

FIGS. 3A and 3B are schematic diagrams for explaining a reproduction principle according to an embodiment;

FIGS. 4A and 4B are schematic diagrams showing the configurations of recording materials;

FIGS. 5A and 5B are schematic diagrams showing the dielectric constant dependence of the near field light intensity;

FIGS. 6A and 6B are schematic diagrams showing the configurations of samples;

FIG. 7 is a schematic diagram showing the scattered light intensity in a crystalline state and an amorphous state;

FIG. 8 is a schematic diagram showing the electric field enhancement factor when the diameter of a Ag central core is changed;

FIG. 9 is a schematic diagram showing the electric field enhancement factor when the thickness of a GeSbTe shell is changed;

FIG. 10 is a schematic diagram showing the resonance condition of silver particle at 400 nm;

FIGS. 11A and 11B are schematic diagrams showing the configuration of an optical information recording medium;

FIGS. 12A and 12B are schematic diagrams showing configurations of recording layers;

FIGS. 13A to 13D are schematic diagrams showing configurations of recording layers;

FIGS. 14A and 14B are schematic diagrams showing configurations of recording layers;

FIG. 15 is a schematic diagram showing a configuration of a recording layer;

FIG. 16 is a schematic diagram showing the configuration of an optical information recording and reproducing apparatus;

FIG. 17 is a schematic diagram showing the configuration of an optical pickup;

FIGS. 18A and 18B are schematic diagrams showing the arrangement of a spot forming portion;

FIGS. 19A and 19B are schematic diagrams showing the configuration of a spot forming portion;

FIG. 20 is a schematic diagram for explaining recording of information;

FIG. 21 is a schematic diagram for explaining reproduction of information;

FIG. 22 is a schematic diagram showing the arrangement of a spot forming portion according to another embodiment;

FIG. 23 is a schematic diagram showing the configuration of a spot forming portion according to another embodiment; and

FIGS. 24A and 24B are schematic diagrams showing the configurations of recording materials according to an embodiment.

### DETAILED DESCRIPTION

The present application will be described below in detail with reference to the drawings according to an embodiment.

### (1) OVERVIEW

In general, it is in the public domain that metals, e.g., Au, Ag, Al, Pt, and Cu, in the state of nanosize (100 nm or less) fine particles (hereafter this is referred to as nanoparticles) react with light when a specific condition is satisfied and, thereby, produce local plasmon resonance.

The local plasmon resonance refers to the state in which regarding a nanoparticle, electromagnetic field oscillation and charge oscillation are coupled and resonance is produced. At this time, localization of strong electromagnetic field occurs in the vicinity of the nanoparticle. This strong electromagnetic field is referred to as a near field.

When the diameter of a nanoparticle is assumed to be a and the wavelength of light incident on the nanoparticle is assumed to be λ, it is believed that if the diameter a is sufficiently smaller than the wavelength λ (a<<λ), a uniform electromagnetic field is applied to the nanoparticle. This is called long wavelength approximation, and the polarizability α of the nanoparticle at this time is represented by the following formula.

$$α = 4 π {a}^{3} \frac{{ɛ}_{1} ( ω ) - {ɛ}_{2}}{{ɛ}_{1} ( ω ) + 2 {ɛ}_{2}} , \qquad ( 1 )$$

where ε₁(ω)=complex dielectric constant of fine particle and ε₂=complex dielectric constant of medium

As is clear from Formula (1), when a denominator of a term of the dielectric constant in the right side approaches “0”, the polarizability increases significantly. At this time, regarding the nanoparticle, resonant oscillation of an electromagnetic field and charge, that is, local plasmon resonance, occurs in accordance with the electromagnetic field inherent to the incident light.

Since the complex dielectric constant ε2 of the medium is 1 in the air, local plasmon resonance occurs when the complex dielectric constant ε1(ω) of the fine particle satisfies the following formulae.

Re|ε1(ω)|+2ε2≈0 (2)

Im|ε1(ω)|<<1 (3)

As is clear from Formula (2) and Formula (3), the nanoparticle produces plasmon resonance when Re, that is, the real part of the complex dielectric constant ε1(ω), is −2 and Im, that is, the imaginary part of the complex dielectric constant ε1(ω), is nearly “0”.

In the case where the incident light is in a visible light region, since a so-called noble metal, e.g., Au or Ag, satisfies the condition represented by Formula (1), Formula (2), and Formula (3), local plasmon resonance is produced in accordance with the incident light in the visible light region.

The nanoparticle forms a near field on the basis of this local plasmon resonance and generates very intense near field light and scattered light. This near field light hardly propagates and has a feature to localize in the vicinity of the nanoparticles. On the other hand, the scattered light has a feature to propagate a long way.

Furthermore, regarding BD (Blu-ray Disc, registered trademark)-RE (Rewritable), DVD (Digital Versatile Disc)±RW (Rewritable), and DVD-RAM (Random Access Memory), a phase change system is adopted. In this phase change system, a light beam is applied to a phase change film formed from a phase change material and, thereby, a crystalline state and an amorphous state (they are collectively referred to as phase state) are changed, so as to form a recording mark on the phase change film.

Regarding this phase change material, the complex dielectric constant is changed in accordance with the change in the phase state. Consequently, it is believed that if local plasmon resonance can be produced in the phase change material, when a light beam with a single wavelength is applied, the degree of local plasmon resonance can be changed in accordance with the phase change and, thereby, the intensity of the scattered light (hereafter this is referred to as scattered light intensity) can be changed significantly.

Here, the relationship between the complex dielectric constant ε1(ω) and the complex refractive index (n, k) is shown by the following formulae.

Re|ε1(ω)|=n2−k2 (4)

Im|ε1(ω)|=2nk (5)

That is, in order to satisfy the above-described relationship represented by Formulae (1), (2), and (3) in the air, it is enough that n=1.414 and k=0 are satisfied substantially.

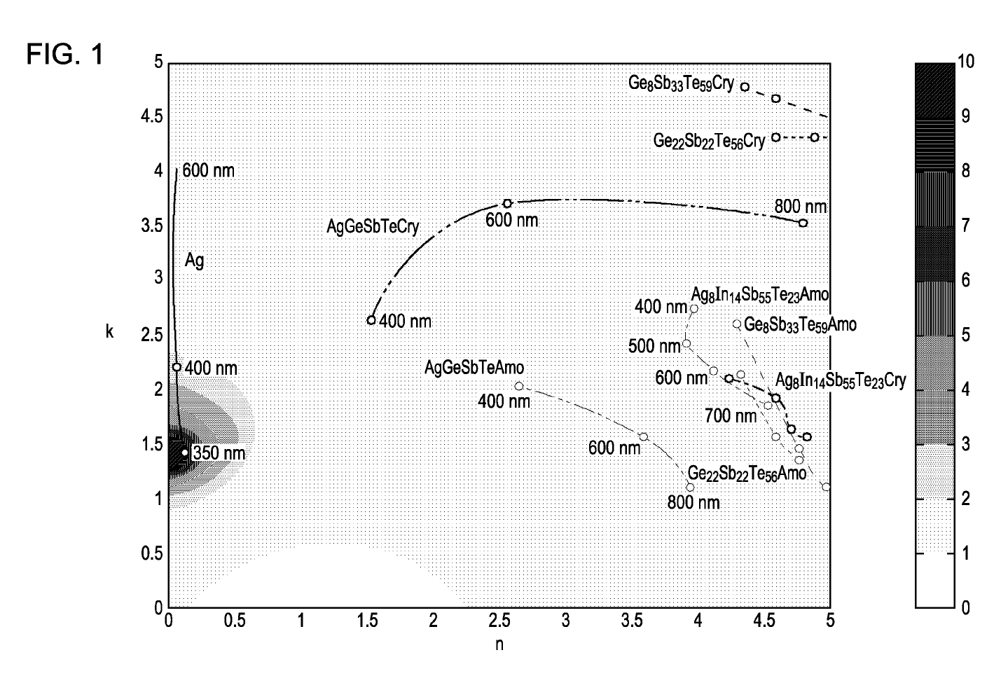

Regarding four types of general phase change materials and Ag, FIG. 1 shows the state of polarization α in a crystalline state (Cry: Crystal) and an amorphous state (Amo: Amorphous) as the relationship between the wavelength λ of an incident light and the complex refractive index N (real part=n, imaginary part=k). In FIG. 1, the polarization α is expressed by light and shade of color, and a darker portion indicates that polarization is large. As for the phase change materials, Ge8Sb33Te59, Ge22Sb22Te56, AgGeSbTe, and Ag8In14Sb55Te23 are shown.

As is clear from FIG. 1, polarization α of the phase change materials is very small at all wavelengths λ and, therefore, no local plasmon resonance is produced. On the other hand, polarization α of Ag is very large at a wavelength λ of about 350 nm and, therefore, it is clear that local plasmon resonance is produced when the incident light has a wavelength λ of about 350 nm.

Furthermore, regarding the phase change materials, it is clear that the values of complex refractive index N (n and k) in the crystalline state and in the amorphous state are different significantly. That is, it is clear that the value of the complex dielectric constants of the phase change materials are changed significantly between the crystalline state and the amorphous state.

Incidentally, as shown in Formula (1), the condition for producing the local plasmon resonance is changed depending on the complex dielectric constant ε2 of a medium, that is, a material present around the nanoparticle.

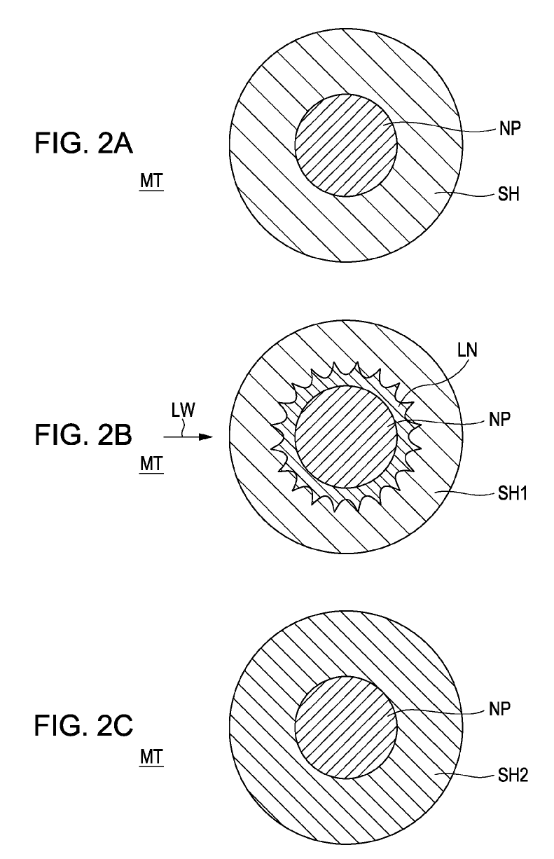

Therefore, in an embodiment, as shown in, for example, FIG. 2A, a material, e.g., the phase change material, in which the state is changed from a first state to a second state in accordance with an application of incident light and the complex dielectric constant is changed in accordance with the change in state, is disposed as a medium SH around the nanoparticle NP, and this serves as a recording material MT. At this time, in an embodiment, the medium SH is selected in such a way that the degree of occurrence of local plasmon resonance is large in the first state and the degree of occurrence of local plasmon resonance becomes small in the second state.

As shown in FIG. 2B, for example, when a recording light beam LW for recording information is applied to a medium SH in the first state (hereafter, this is referred to as medium SH1), local plasmon resonance is produced at an interface between the nanoparticle NP and the medium SH1.

At this time, the recording material MT generates very intense near field light LN in the vicinity of the outside of the nanoparticle NP. Consequently, as shown in FIG. 2C, the recording material MT can change the medium SH to, for example, the second state, in which the complex dielectric constant ε2 is different from that in the first state, (hereafter, this is referred to as medium SH2) in a very short time.

That is, regarding the recording material MT, the information can be recorded in accordance with the recording light beam LW by changing the state of the medium SH. Moreover, the information can be recorded with relatively small light energy through the use of local plasmon resonance.

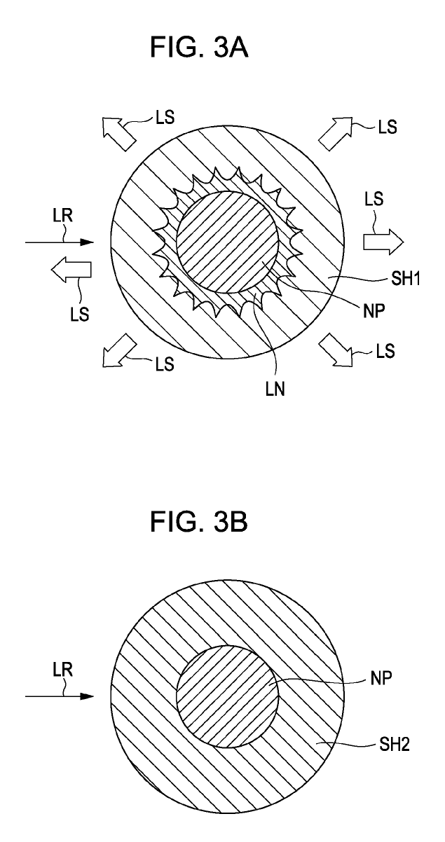

Furthermore, as shown in FIG. 3A, regarding the recording material MT in which the medium SH is in the first state, when a reading light beam LR for reading the information is applied, a large degree of local plasmon resonance is produced at an interface between the nanoparticle NP and the medium SH1 on the basis of the relationship with the complex dielectric constant ε2. At this time, the recording material MT generates very intense near field light LN in the vicinity of the outside of the nanoparticle NP and, in addition, also generates high intensity scattered light LS.

Since this scattered light LS propagates a long way, a part of the scattered light LS can be received as returned light. That is, in the case where the medium SH of the recording material MT is in the first state, relatively high intensity scattered light LS due to a large degree of local plasmon resonance can be received as returned light.

On the other hand, as shown in FIG. 3B, regarding the recording material MT in which the medium SH is in the second state, when a reading light beam LR is applied, a small degree of local plasmon resonance is produced at an interface between the nanoparticle NP and the medium SH2 on the basis of the relationship with the complex dielectric constant ε2, and only low intensity scattered light LS is generated. Consequently, in the case where the medium SH of the recording material MT is in the second state, low intensity scattered light LS due to a small degree of local plasmon resonance can be received as returned light.

That is, regarding the recording material MT, it is possible to detect the state of the medium SH (that is, whether in the first state or in the second state) in the recording material MT on the basis of the amount of received light of scattered light beam LSa.

As described above, regarding the recording material MT, the information can be recorded on and reproduced from the recording material MT by enveloping the nanoparticle NP in the medium SH and changing the state of the medium SH so as to change the degree of local plasmon resonance.

### (2) CONFIGURATION OF RECORDING MATERIAL

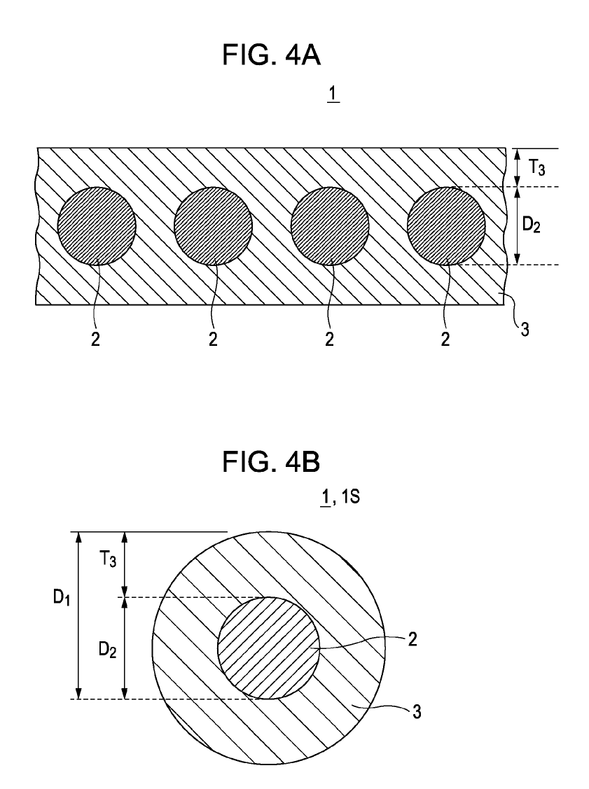

As shown in FIGS. 4A and 4B, the recording material 1 has a configuration in which individual nanoparticles 2 are surrounded by a medium 3. Regarding this recording material 1, as shown in, for example, FIG. 4A, nanoparticles 2 may be embedded in the medium 3.

Alternatively, as shown in FIG. 4B, the recording material 1 may be formed into the shape of a particle in which a nanoparticle 2 serves as a central core and a medium 3 serves as an outer shell. Hereafter, this recording material 1 formed into the shape of a particle is referred to as a recording particle 1S.

The material for the nanoparticle 2 is not specifically limited. However, it is preferable that the material is easy to polarize to a large degree. In particular, a metal is preferable. Furthermore, as for the nanoparticle 2, Pt, Ag, Au, Al, or Cu is preferable. It is in the public domain that they produce local plasmon resonance in accordance with the light in the visible light region. In particular, Ag or Au is preferable because it is believed that a large degree of local plasmon resonance is produced.

Preferably, the diameter D2 of the nanoparticle 2 is 1 nm or more. If the diameter D2 of the nanoparticle 2 is less than 1 nm, it is difficult to obtain stability as a particle. Furthermore, preferably, the diameter of the nanoparticle 2 is 50 nm or less. If the diameter D2 exceeds 50 nm, the degree of local plasmon resonance is reduced. It is preferable that the diameter D2 of the nanoparticle 2 is 20 nm or less, and furthermore, 15 nm or less from the viewpoint of the memory density.

Moreover, the medium 3 is formed from a material which changes the state thereof and the complex dielectric constant ε2 in accordance with the light having a predetermined degree of or more intensity. Examples of the changes of the state include phase change in which a crystalline state and an amorphous state are changed and oxidation in which oxidation is effected in accordance with the light. That is, it is preferable that the material for the medium 3 is an oxidizing material or a phase change material, and in particular, the phase change material is preferable. This is because these materials have been adopted for BD-RE and the like.

In addition, in the case where a phase change material which effects reversible state change is used, the information can be rewritten a plurality of times. In this case, it is possible that the medium 3 in the recording material 1 is heated to a first temperature so as to come into the crystalline state and the medium 3 is heated to a second temperature lower than the first temperature so as to come into the amorphous state.

Furthermore, it is preferable that the medium 3 is selected in such a way that the degree of local plasmon resonance is reduced in the amorphous state. This is because regarding the phase change material, the free energy thereof in the amorphous state is higher than that in the crystalline state, and the state is unstable as compared with the crystalline state, but in the reproduction of information, a temperature increase of the recording material 1 in the amorphous state can be suppressed so as to increase the times of reproduction.

The material for the medium 3 is not specifically limited. However, inorganic materials, e.g., dielectric materials, semiconductor materials, semimetal materials, and metal materials, in which polarization occurs, are preferable. In addition, it is preferable that a semiconductor material is contained as at least a part thereof. It is particularly preferable that the medium 3 is a combination of a plurality of types of inorganic materials. This is because the amount of change in the complex dielectric constant ε2 and the like is adjusted easily by changing the composition. As for this inorganic material, for example, it is preferable that semiconductor materials and semimetal materials, e.g., Ge, Sb, and Te, and metal materials, e.g., Ag, are combined appropriately.

Preferably, the thickness T3 of the medium 3 up to the surface is 1 nm or more. If the thickness T3 is less than 1 nm, it is difficult to exert the characteristics of the medium 3 sufficiently with respect to the nanoparticle 2. Preferably, the thickness T3 of the medium 3 is less than 50 nm. If the thickness T3 is 50 nm or more, near field light does not reach the surface of the medium 3 sufficiently. It is further preferable that the thickness T3 of the medium 3 is 20 nm or less, and more preferably 10 nm or less. This is because absorption of the scattered light LSa is minimized.

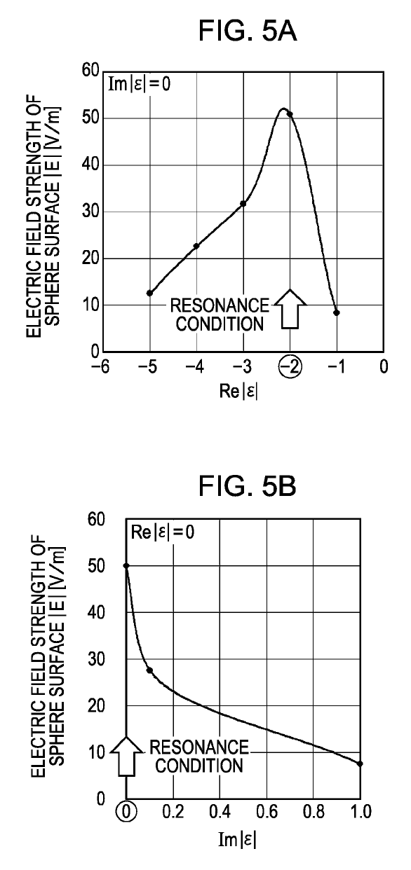

Moreover, the value of the left side of Formula (2) with respect to the nanoparticle 2 and the medium 3 in one state is different from the value of the left side of Formula (2) with respect to the nanoparticle 2 and the medium 3 in the other state. This is for the purpose of changing the degree of local plasmon resonance. In addition, it is preferable that the nanoparticle 2 and the medium 3 in the one state satisfy formula (2). FIGS. 5A and 5B are graphs showing an influence of the dielectric constant (real part and imaginary part) of the medium 3 on the local plasmon resonance of a Ag particle having a diameter of 60 nm. As is indicated by a graph of the real part shown in FIG. 5A, when the real part in the value of the left side is 1 or less, the electric field strength becomes 20 V/m or more, and when the real part is 0.5 or less, the electric field strength becomes 400 V/m or more. Therefore, it is preferable that the real part in the value of the left side is 1 or less, and more preferably 0.5 or less. Furthermore, as is indicated by a graph of the imaginary part shown in FIG. 5B, it is preferable that the imaginary part in the value of the left side is 0.6 or less, more preferably 0.4 or less, and further preferably 0.05 or less. On the other hand, it is preferable that the nanoparticle 2 and the medium 3 in the other state do not satisfy formula (2) (that is, the real part in the value of the left side of Formula (2) is larger than 1 and the imaginary part in the value of the left side of Formula (2) is larger than 0.4). Moreover, it is preferable that the value of the left side of Formula (3) is 0.5 or less, and more preferably 0.3 or less, the value being determined by only the nanoparticle 2. This is because the degree of local plasmon resonance is affected.

Consequently, when the recording material 1 is in the one state, a large degree of local plasmon resonance is produced, whereas in the other state, the local plasmon resonance is hardly produced. Therefore, it becomes possible to change the amount of light of the returned scattered light beam LS to a large extent in accordance with the state of the medium 3 in the recording material 1.

Furthermore, in the case where the recording material is a recording particle 1S as shown in FIG. 4B, preferably, the diameter D1 of the recording particle 1S is 3 nm or more. This is because the characteristics as the recording particles 1S are maintained. It is preferable that the diameter D1 of the recording particle 1S is 52 nm or less, and furthermore, 20 nm or less from the viewpoint of the memory density.

Specifically, this recording particles 1S are produced, for example, as described below. For example, in the case where Ag is used as the nanoparticle 2, an ethanol solution or an aqueous solution of silver nitrate (AgNO3) is prepared, an alkanethiol derivative and NaBH4 serving as a reducing agent are added, and agitation is conducted so as to coagulate silver particles to a predetermined size.

In the case where, for example, GeSbTe is used as the medium 3, an ethanol solution or an aqueous solution containing Ge, Sb, and Te is mixed to an ethanol solution or an aqueous solution containing silver particles, and agitation is conducted, for example, at 0° C. for a predetermined time. Alternatively, it is possible to add a compound containing Ge, Sb, and Te directly to a silver nitrate solution, or add coagulated silver particles to an ethanol solution or an aqueous solution containing Ge, Sb, and Te. Thereafter, water or ethanol is vaporized and, thereby, recording particles 1S are obtained.

In this regard, the proportions of Ge, Sb, and Te can be changed appropriately by changing the concentrations of Ge, Sb, and Te. Furthermore, the diameter of a silver particle serving as the nanoparticle and the thickness of GeSbTe serving as the medium 3 can be changed appropriately by changing the agitation time. Moreover, the recording particle 1S can be produced by various method besides this.

### (3) EXAMPLES

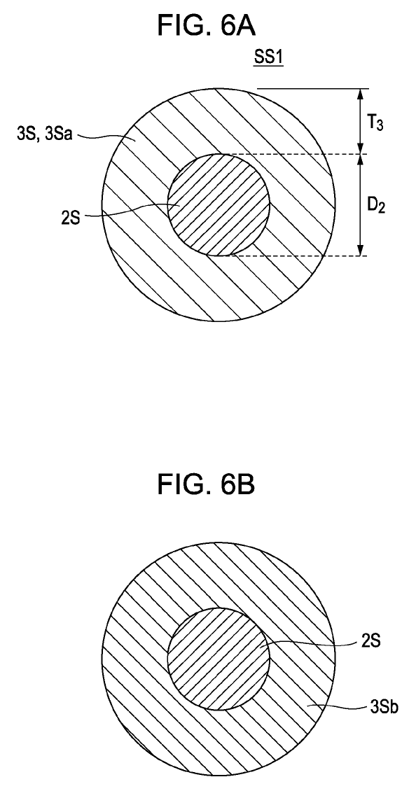

The examples will be described below. In the present example, simulation was conducted with respect to the scattered light intensity of recording particles 1S as shown in FIGS. 6A and 6B. Regarding the recording particle 1S, Ag was used as the nanoparticle 2 and GeSbTe (composition ratio 2:2:5) formed from a phase change material was used as the medium 3. In the present example, this recording particle 1S is referred to as a sample SS1, and the nanoparticle 2 and the medium 3 in the sample SS1 are referred to as a Ag central core 2S and a GeSbTe shell 3S, respectively.

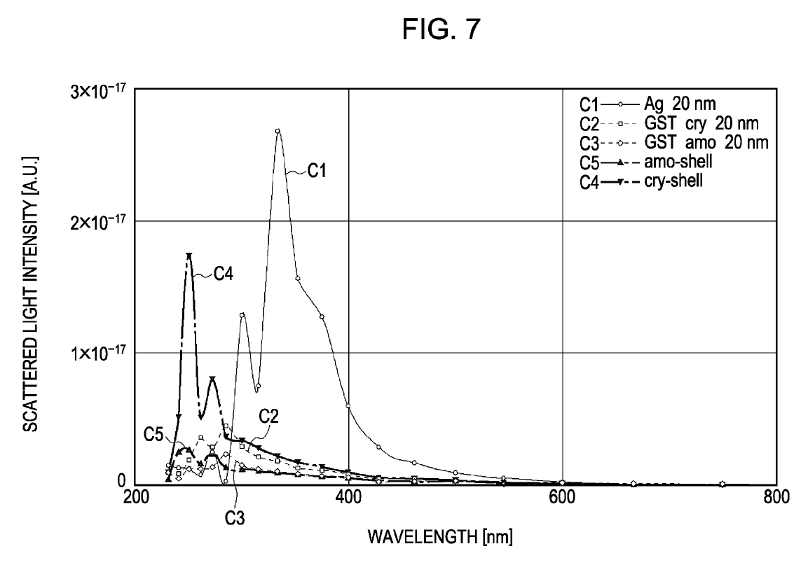

FIG. 7 shows the relationship between the wavelength and the scattered light intensity. FIG. 7 shows the results calculated by using a finite differential time domain method. Incidentally, regarding the sample SS1 used for the calculation related to FIG. 7, the diameter D2 of the Ag central core 2S was 15 nm, the thickness T3 of the GeSbTe shell 3S was 2.5 nm, and the diameter D1 of the sample SS1 was 20 nm.

The curve C1 indicates the scattered light intensity of a nanoparticle having a diameter of 20 nm of Ag simple substance. It is clear that local plasmon resonance was produced at a wavelength λ of about 350 nm and high intensity scattered light was generated.

The curve C2 indicates the scattered light intensity of a nanoparticle having a diameter of 20 nm of GeSbTe simple substance in the crystalline state. The scattered light intensity is maximum at about 280 nm, but the intensity is not so high.

The curve C3 indicates the scattered light intensity of a nanoparticle having a diameter of 20 nm of GeSbTe simple substance in the amorphous state. The scattered light intensity is maximum at about 280 nm, but the intensity is very low.

As is suggested by the curves C2 and C3, regarding the nanoparticle of the GeSbTe simple substance, even in the case where the scattered light intensity in the crystalline state is maximum, the intensity thereof is low, and sufficient returned light is hardly obtained. Furthermore, a difference between the crystalline state and the amorphous state is small, and it is difficult to detect the difference therebetween from the scattered light LS.

The curve C4 indicates the scattered light intensity in the case where the GeSbTe shell 3S in the sample SS1 is in the crystalline state (hereafter, this is referred to as crystalline-state sample SS1a). The crystalline-state sample SS1a shows very high scattered light intensity at about 240 nm, and it is clear that large local plasmon resonance is produced at about 240 nm. Furthermore, the crystalline-state sample SS1a shows relatively high scattered light intensity at a wavelength λ between about 220 nm and about 360 nm.

The curve C5 indicates the scattered light intensity in the case where the GeSbTe shell 3S in the sample SS1 is in the amorphous state (hereafter, this is referred to as amorphous-state sample SS1b). The amorphous-state sample SS1b has a peak at about 240 nm as in the crystalline-state sample SS1a, but the scattered light intensity is very low. Consequently, it is clear that the amorphous-state sample SS1b produces local plasmon resonance at about 240 nm, but the degree thereof is very small.

As is clear from these results, the degree of local plasmon resonance can be changed in accordance with the crystalline state of the GeSbTe shell 3S by applying incident light (that is, a recording light beam LW or a reading light beam LR) with 240 nm to the sample SS1. That is, it was ascertained that the information was able to be recorded and reproduced by using the sample SS1 and by changing the crystalline state of the GeSbTe shell 3S so as to change the degree of local plasmon resonance.

In this regard, the complex dielectric constant ε2 of the GeSbTe shell 3S in the crystalline-state sample SS1a at a wavelength λ of 240 nm is 1.315-0.5174i and, therefore, Formula (2), which is the condition of local plasmon resonance, is satisfied. On the other hand, the complex dielectric constant ε2 of the GeSbTe shell 3S in the amorphous-state sample SS1b is 5.064-1.157i and, therefore, Formula (2) is not satisfied. This matches with the fact that a large peak was observed in the scattered light intensity of the crystalline-state sample SS1a in FIG. 7, whereas a large peak was not observed with respect to the amorphous-state sample SS1b.

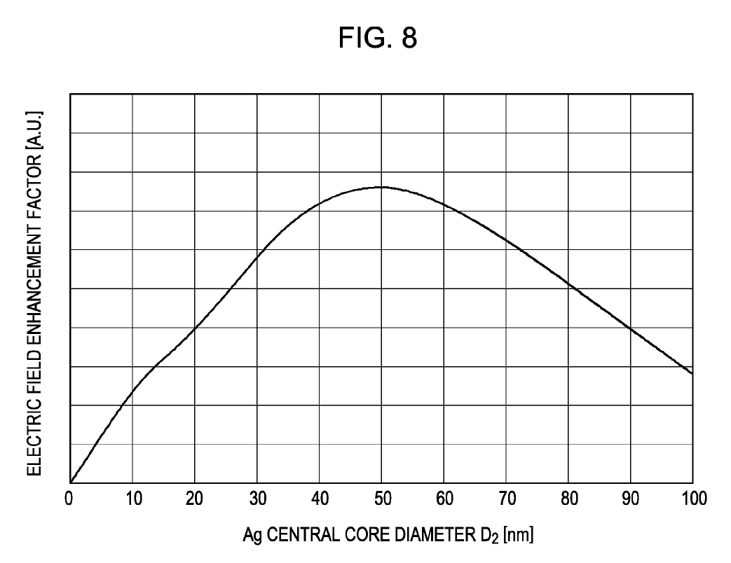

Next, the electric field enhancement factor was calculated in the case where the thickness T3 of the GeSbTe shell 3S was fixed at 2.5 nm and incident light with a wavelength λ of 360 nm was applied to the sample SS1 where the diameter D2 of the Ag central core was changed. The results are shown in FIG. 8. In this regard, the electric field enhancement factor indicates the degree of enhancement of an electric field on the fine particle surface (that is, a surface of the sample SS1) relative to the incident light intensity (that is, electric field). In FIG. 8, the value of the intersection point of the vertical axis with the horizontal axis is zero and simply indicates the degree of enhancement of the electric field, that is the degree of production of local plasmon resonance.

The electric field enhancement factor increases as the diameter D2 of the Ag central core 2S increases from 0 nm, and becomes substantially maximum when the diameter D2 is 50 nm. Furthermore, since the recording density can be improved as the diameter D2 of the Ag central core 2S becomes smaller, it is preferable that the diameter D2 is 50 nm or less. From the viewpoint of the recording density, a still smaller diameter D2 is preferable. For example, in order to achieve the recording density of 1 bit/inch or more, it is preferable that the diameter D2 is specified to be 18 nm or less, and furthermore, 15 nm or less.

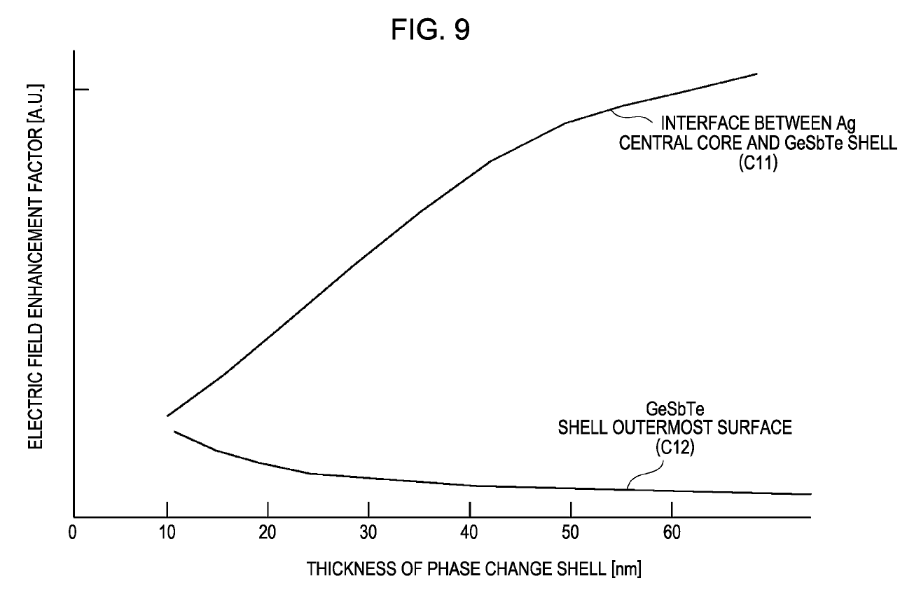

Subsequently, the electric field enhancement factor was calculated in the case where the diameter D2 of the Ag central core 2S was fixed at 15 nm, and incident light with a wavelength λ of 360 nm was applied to the sample SS1 where the thickness T3 of the GeSbTe shell 3S was changed. The results are shown in FIG. 9.

The curve C11 indicates the electric field enhancement factor, that is, the degree of local plasmon resonance, at an interface between the Ag central core 2S and the GeSbTe shell 3S. The electric field enhancement factor increases as the thickness T3 of the GeSbTe shell 3S increases. The reason therefor is believed to be that as the thickness T3 of the GeSbTe shell 3S increases, the GeSbTe shell 3S exerts the characteristics as the medium.

The curve 12 indicates the electric field enhancement factor on a surface of the sample SS1, that is, at an interface between the GeSbTe shell 3S and the air. As the thickness T3 of the GeSbTe shell 3S increases, the electric field enhancement factor decreases gradually. This is because as the thickness T3 of the GeSbTe shell 3S increases, the distance from the interface, at which local plasmon resonance is produced, between the Ag central core 2S and the GeSbTe shell 3S increases.

That is, it is clear that as the thickness T3 of the GeSbTe shell 3S increases, the degree of local plasmon resonance increases, the electric field on the surface of the sample SS1 is reduced, conversely, and the crystalline state of the GeSbTe shell 3S may be insufficiently changed. In general, it is believed that the range of very intense near field light is about a radius of the nanoparticle 2. Therefore, it is preferable that the thickness T3 of the GeSbTe shell 3S is controlled at nearly twice the radius, that is, nearly the diameter D2 of the nanoparticle 2. In FIG. 9, since the diameter of the Ag central core 2S is 15 nm, practically, when the thickness T3 of the GeSbTe shell 3S becomes 15 nm or more, the electric field enhancement factor decreases sharply.

Incidentally, regarding FIG. 8 and FIG. 9, the values of electric field enhancement factors of the crystalline-state sample SS1a and the amorphous-state sample SS1b are different, but nearly analogous curves were obtained. That is, the above-described results are applicable to both crystalline-state sample SS1a and amorphous-state sample SS1b.

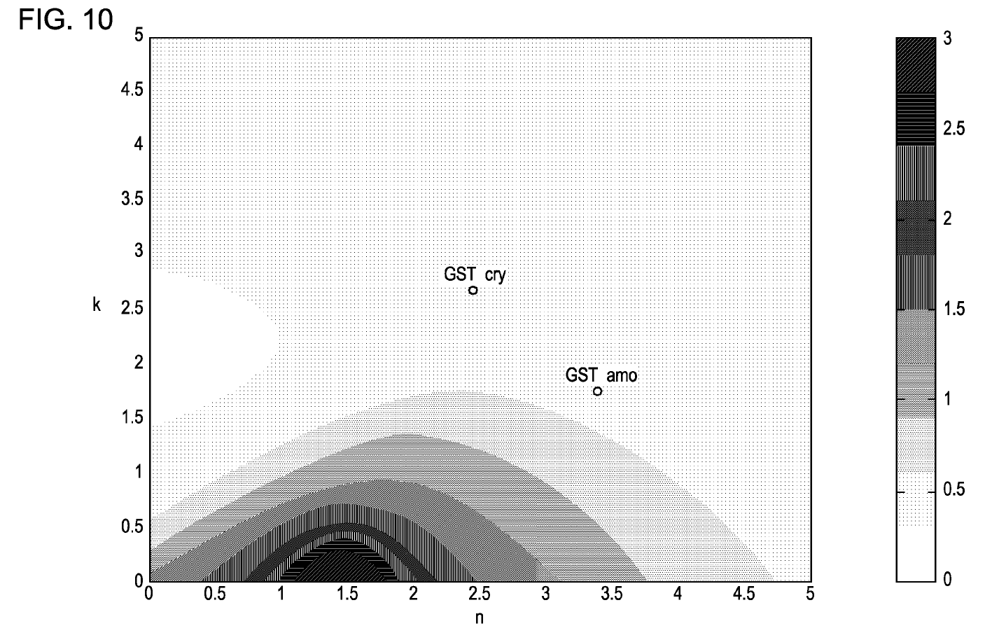

FIG. 10 shows polarization α in the case where the wavelength λ of the incident light is 400 nm. Regarding the sample SS1 used for the calculation with respect to FIG. 10, the diameter D2 of the Ag central core 2S was 15 nm, the thickness T3 of the GeSbTe shell 3S was 2.5 nm, and the diameter D1 of the sample SS1 was 20 nm. Furthermore, the calculation was conducted on the assumption that the complex refractive index of the Ag central core 2S was n=0.173 and k=1.95.

As is clear from FIG. 10, the complex refractive index of the medium 3 to produce local plasmon resonance with respect to the incident light with a wavelength λ of 400 nm is n=1.5 and k=0. Regarding the GeSbTe shell 3S, the complex refractive index in the crystalline state is n=2.0 and k=3.0, the complex refractive index in the amorphous state is n=3.0 and k=2.0 and, therefore, they are far from the above-described condition.

Put another way, it is clear that the incident light with a wavelength λ of 400 nm can be used as the recording light beam LW and the reading light beam LR by selecting a phase change material which takes on a value of the complex refractive index in the vicinity of n=1.5 and k=0 in any one of the crystalline state and the amorphous state.

It is believed that in FIG. 10, the GeSbTe shell 3S in the crystalline state is located at a position in the vicinity of the region, in which polarization α is high, as compared with that in the amorphous state, and this difference leads to the difference in the scattered light intensity as shown in FIG. 7.

As described above, it was ascertained that the degree of local plasmon resonance was able to be changed to a large degree particularly in the vicinity of 240 nm by using the Ag central core 2S as the nanoparticle 2 and the GeSbTe shell 3S as the medium 3. Furthermore, it was ascertained that the wavelength λ of the incident light was able to be set at 400 nm by selecting a material in such a way that the complex refractive index of the medium 3 takes on a value in the vicinity of n=1.5 and k=0 in any one of the crystalline state and the amorphous state.

### (4) CONFIGURATION OF OPTICAL INFORMATION RECORDING MEDIUM

An optical information recording medium 100 is formed into the shape of a disc having a diameter of about 120 mm as a whole in a manner similar to CD, DVD, and BD in the related art, and a hole portion 100H is disposed in a central portion. The shape of the optical information recording medium 100 is not specifically limited and may be rectangular or polygonal. The hole portion 100H is not necessarily disposed.

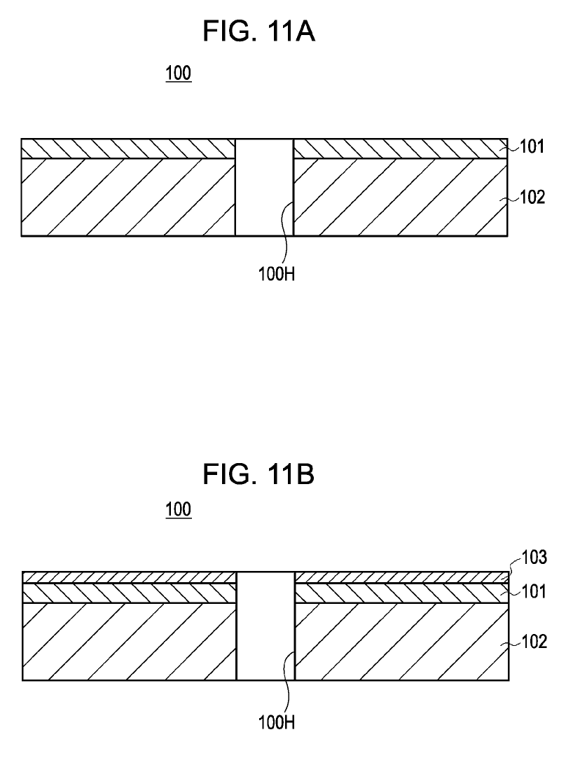

FIG. 11A is a sectional view of the optical information recording medium 100. A recording layer 101 for recording information is disposed on a substrate 102. In this regard, the thickness of the substrate 102 is selected within the range of 0.05 mm to 1.20 mm appropriately.

As for the substrate 102, at least one type of hard material is used in order to maintain the physical strength of the optical information recording medium 100. The substrate 102 is formed from, for example, a resin material, e.g., polycarbonate or polymethyl methacrylate, or an inorganic material, e.g., glass or ceramic. As for the substrate 102, a material having a low transmittance may be used. However, it is preferable that a material having a high transmittance is used. This is for the purpose of preventing excess light other than the scattered light beam LSa from being reflected and received together with returned light.

In the case where the optical information recording medium 100 is used as exchangeable media in a manner similar to DVD and BD, a resin material suitable for mass-production is used favorably. On the other hand, in the case where the optical information recording medium 100 is used as medium fixed to a drive as in hard disk and the like, a highly precise inorganic material which is not easily affected by an ambient environment is used favorably.

The interface between the substrate 102 and the recording layer 101 may be subjected to an antireflection coating (AR) treatment with an inorganic multilayer (for example, four layers of Nb2O2/SiO2/Nb2O5/SiO2) so as to become nonreflective with respect to the wavelength of the light beam used as the incident light. This is for the purpose of preventing light other than the scattered light beam LSa from being received together with returned light.

Furthermore, as shown in FIG. 11B, a protective layer 103 for protecting the recording layer 101 may be disposed on the recording layer 101. As for this protective layer 103, for example, a scratchproof hard coat layer or the like is disposed through sputtering, evaporation, spin coating, or the like.

It is preferable that the thickness of the protective layer 103 is 10 nm or less, and more preferably 5 nm or less. This is for the purpose of allowing the near field light incident from a plasmon antenna (described in detail later) to reach the recording layer 101. In this regard, a lubricating layer for improving the sliding performance may be disposed instead of the protective layer 103 or on the protective layer 103. As for this lubricating layer, a silicon compound, a fluorine compound, or the like is used.

The recording layer 101 is formed by disposing a recording material 1 on the substrate 102. That is, it is enough that the nanoparticles 2 are surrounded by a medium 3. Nanoparticles 2 may be embedded in the inside of the medium 3, or recording particles 1S may be disposed. A track TR is formed in the shape of, for example, concentric circles or a spiral, on the recording layer 101, and information is recorded along the track TR. As for the track TR, a land and a groove composed of a concave and a convex may be formed as those of, for example, DVD and BD, or the surface thereof may be flat as that of hard disk.

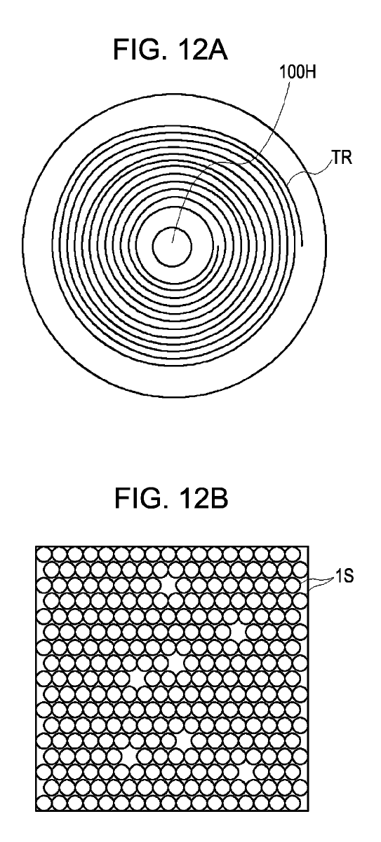

Furthermore, in the recording layer 101, the nanoparticles 2 may be disposed only in the track TR, as shown in FIG. 12A, or be disposed in such a way as to be laid all over the recording layer 101 (that is, also on places other than the track TR).

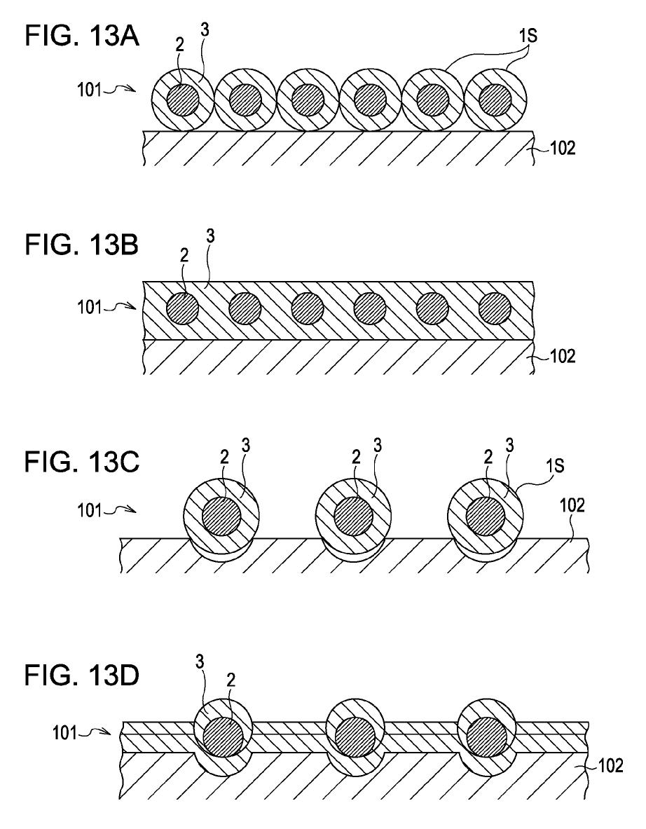

As shown in FIG. 12B, the nanoparticles 2 can be laid all over the recording layer 101 by laying the recording particles 1S all over the recording layer 101. For example, a Langmuir Blodgett (LB) method through the use of a LB trough may be employed. That is, the recording particles 1S with a chloroform solvent are dropped on a water surface of the LB trough. After the chloroform is vaporized, the recording particles 1S remaining on the water surface are compressed by a barrier which is moved at a constant speed, and a hydrogen-terminated substrate 102 is pulled up, so that transfer is conducted. Consequently, as shown in FIG. 13A, the recording particles 1S are laid over the substrate 102.

In this case, in the recording layer 101, for example, 1 bit of information may be recorded with respect to one recording particle 1S, or 1 bit of information may be recorded with respect to a plurality of recording particles 1S. Regarding this recording layer 101, a track TR, on which the information is recorded, is formed only after an address information and the like are written through, for example, initialization in production.

Alternatively, as shown in FIG. 13B, the recording layer may be formed by embedding nanoparticles 2 in the inside of the medium 3.

Next, the case where the nanoparticles 2 are disposed on the track TR by arraying the recording particles 1S only on the track TR will be described. Concaves are formed in advance on the substrate 102 by, for example, a nanoimprinting method through the use of electron beam exposure and lithography, the resulting substrate 102 is immersed into an aqueous solution, in which the recording particles 1S are dispersed, and the substrate 102 is pulled up slowly. Consequently, as shown in FIG. 13C, the recording particles 1S are arrayed on the concaves. Incidentally, this technique is described in Japanese Unexamined Patent Application Publication No. 2005-138011. In this regard, it is also possible to lay the recording particles 1S all over the recording layer 101 by using this method, as a matter of course.

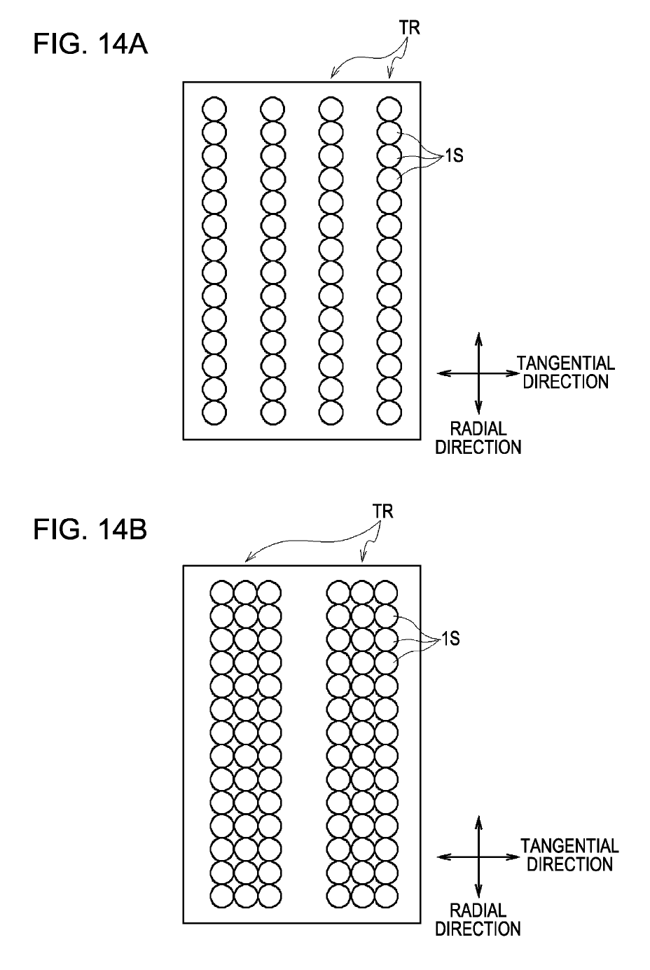

In this case, as shown in FIG. 14A, a line of recording particles 1S may be arrayed with respect to one track TR. At this time, 1 bit of information may be recorded with respect to one recording particle 1S, or 1 bit of information may be recorded with respect to a plurality of recording particles 1S. Alternatively, as shown in FIG. 14B, a plurality of lines of recording particles 1S may be arrayed with respect to one track TR.

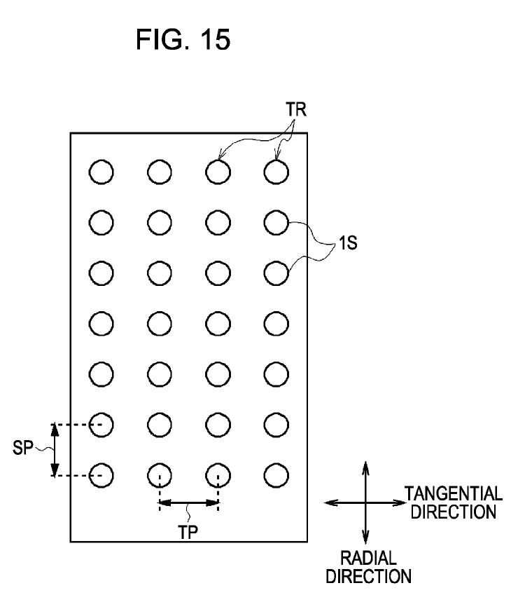

As shown in FIG. 15, individual recording particles 1S may be arrayed separately from each other. At this time, it is preferable that individual recording particles 1S are arranged separately at predetermined intervals SP in a tangential direction (that is, a scanning direction of the track) orthogonal to a radial direction which is a radius direction of an optical information recording medium 100. Consequently, crosstalk between recording particles 1S can be suppressed.

The track pitch at this time is not specifically limited. However, it is preferable that the track pitch TP is set to be, for example, 1.2 times or more, and 3.0 times or less the recording particle 1S in order to prevent crosstalk effectively and avoid significant reduction in recording density. The same goes for the interval SP in the tangential direction.

Furthermore, a method for disposing the nanoparticles 2 on the track TR will be described. After concaves are formed on the substrate 102 through, for example, etching by using, for example, a nanoimprinting method, a layer of the medium 3 is formed through sputtering. As a result, the surface of the substrate 102 is covered with the medium 3 while having concaves. Subsequently, the nanoparticles 2 are arranged on the concaves by s similar pulling-up method, and a layer of the medium 3 is formed again through sputtering. As a result, as shown in FIG. 13D, the nanoparticles 2 can be arrayed only on the track TR while the nanoparticles 2 are in the state of being surrounded by the medium 3. Regarding this method, the nanoparticles 2 can be laid all over the recording layer 101 by changing a pattern of the concaves.

Moreover, the method for manufacturing the recording layer 101 is not limited to them. The recording layer 101 can be produced by using other various methods.

As described above, regarding the optical information recording medium 100, the recording layer 101 in which the nanoparticles 2 are in the state of being surrounded by the medium 3 can be formed on the substrate 102. At this time, the production process of the optical information recording medium 100 can be relatively simplified by arraying recording particles 1S, in which the nanoparticles 2 are surrounded by the medium 3 in advance, on the substrate 102.

### (5) RECORDING AND REPRODUCTION OF INFORMATION

(5-1) Configuration of Optical Information Recording and Reproducing Apparatus

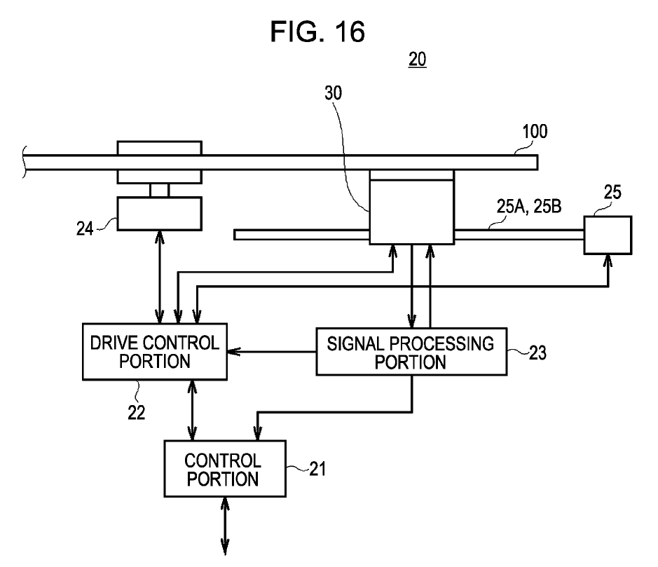

In FIG. 16, reference numeral 20 denotes an optical information recording apparatus as a whole. This optical disk drive 20 is subjected to centralized control by control portion 21 composed of a central processing unit (CPU), read only memory (ROM), and random access memory (RAM), although not shown in the drawing.

For convenience in explanation, the case where information is recorded on and reproduced from the optical information recording medium 100, in which the recording layer 101 is formed by arraying the recording particles 1S on the substrate 102, will be described.

The control portion 21 expands a basic program, an information recording and reproducing program, and the like, which have been stored in ROM, in RAM and, thereby, executes a reproduction treatment and a recording treatment with respect to the optical information recording medium 100 on the basis of the above-described programs.

In the reproduction treatment, the control portion 21 sends out a data reading command together with address information for identifying the data to be read from the optical information recording medium 100 to a drive control portion 22.

The drive control portion 22 controls a spindle motor 24 in accordance with the data reading command from the control portion 21 and, thereby, rotates the optical information recording medium 100 at a predetermined rotation speed and controls a thread motor 25 on the basis of the data reading command and the address information, so that an optical pickup 30 is moved in the radius direction of the optical information recording medium 100.

Then, the control portion 21 allows a recording and reproducing light source 31 of the optical pickup 30 to emit a reading light beam LR with a predetermined wavelength λ to the track in accordance with the address information in an information recording layer of the optical information recording medium 100. The reading light beam LR is condensed by a spot forming portion 40 and is applied to the optical information recording medium 100.

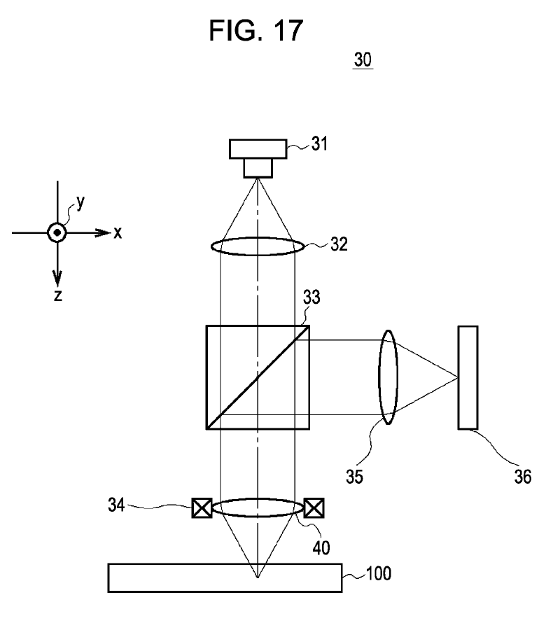

That is, as shown in FIG. 17, the recording and reproducing light source 31 of the optical pickup 30 emits the reading light beam LR at an amount of light in accordance with the reproduction treatment into a collimator lens 32. The collimator lens 32 converts the light beam incident as diverging rays to parallel rays and allows the parallel rays to enter a beam splitter 33.

The beam splitter 33 allows most of the incident light beam to pass through as-is and enter the spot forming portion 40. Subsequently, the spot forming portion 40 condenses the reading light beam LR and applies to the optical information recording medium 100.

The spot forming portion 40 receives returned scattered light beam LSa, which is returned from the optical information recording medium 100 in accordance with the reading light beam LR, and allows the beam LSa to enter the beam splitter 33.

The beam splitter 33 reflects the incident returned scattered light beam LSa, changes the direction thereof by 90°, and allows the beam LSa to enter a light receiving element 36 through a condenser lens 35. Then, the light receiving element 36 subjects the returned scattered light beam LSa to photoelectric conversion so as to generate a light reception signal and feed the detection signal to a signal processing portion 23 (FIG. 16).

The signal processing portion 23 generates a reproduction RF signal representing the total amount of the returned scattered light beam LSa on the basis of the light reception signal and send out to external apparatuses (not shown in the drawing).

At this time, the drive control section 22 focuses the reading light beam LR on a desired track of the optical information recording medium 100 by moving an objective lens 37 in two directions of a tracking direction which is the radius direction of the optical disk and a focusing direction which is a direction to approach or leave the optical disk.

Furthermore, in the recording treatment, the control portion 21 sends out a data writing command together with address information for specifying the data recording place in the information recording layer of the optical disk 100 to a drive control portion 22. The drive control portion 22 control the position of the optical pickup 30 on the basis of the fed address information.

Moreover, the control portion 21 controls the optical pickup 30 on the basis of the writing data input from the external apparatuses (not shown in the drawing), focuses the recording light beam LW on the track in accordance with the address information in the recording layer 101 of the optical disk 100, and applies the recording light beam LW adjusted to have intensity suitable for data recording, so as to record the writing data on the optical information recording medium 100.

As described above, regarding the optical disk drive 20, a reproduction and recording treatment of information is conducted with respect to the optical information recording medium 100.

(5-2) Spot Forming Portion

The spot forming portion 40 will be described below.

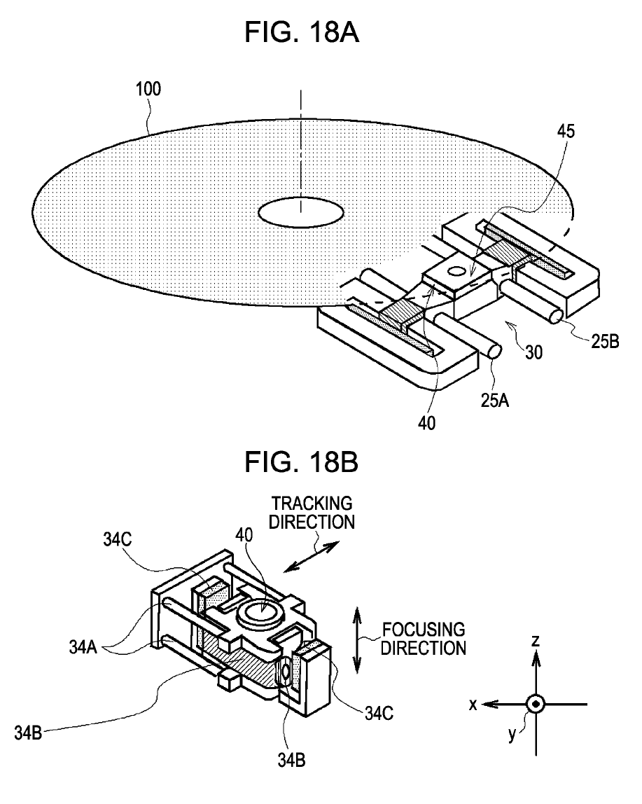

As shown in FIG. 18A, the optical pickup 30 is moved along guide shafts 25A and 25B disposed parallel to an incident surface of the optical information recording medium 100. The optical pickup 30 is provided with a lens holding portion 45 in such a way that the spot forming portion 40 is opposed to the incident surface of the optical information recording medium 100, and the gap between the spot forming portion 40 and the optical information recording medium 100 is set at, for example, less than 20 nm.

As shown in FIG. 18B, the lens holding portion 45 is attached to the optical pickup 30 with four support wires 34A parallel to a direction orthogonal to the tracking direction. A voice coil motor 43B is attached to the outside of the lens holding portion 45, and the voice coil motor 43B is opposed to a magnet 34C. The lens holding portion 45 is driven in a tracking direction and a focusing direction by a thrust produced between a magnet 34 and the lens holding portion 45 in accordance with a current passing the voice coil motor 43B.

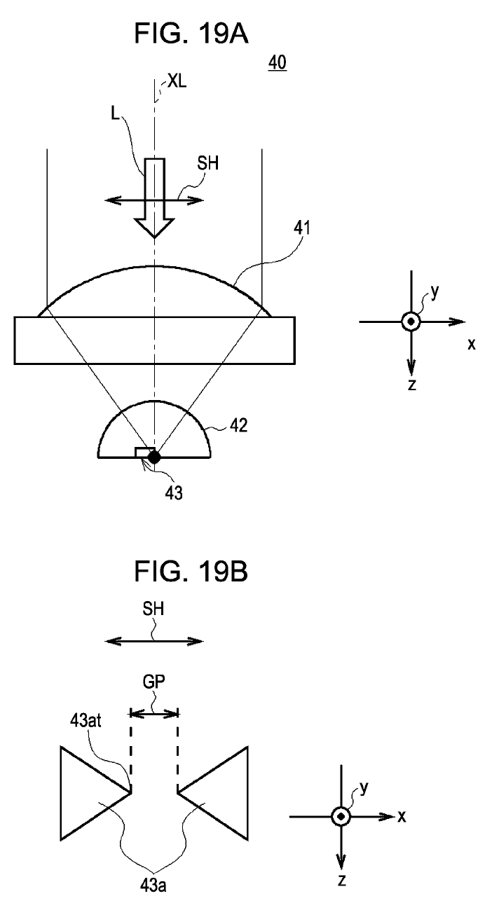

As shown in FIGS. 19A, the spot forming portion 40 includes a condenser lens 41, a solid immersion lens 42, and a plasmon antenna 43.

The condenser lens 41 is composed of an aspheric lens produced by molding an optical material, e.g., glass or plastic. The condenser lens 41 condenses incident light (reading light beam LR and recording light beam LW) and allows the resulting light to enter the solid immersion lens 42.

The solid immersion lens 42 is composed of a semispherical or hyper-semispherical lens which is produced by flattening a part of a high refractive index (for example, n=1.92) sphere. The solid immersion lens 42 condenses the incident light in accordance with the refractive index with numerical aperture (NA) larger than the condenser lens 41.

The condensed incident light comes into a focus at an end of the solid immersion lens 42. The plasmon antenna 43 is disposed at the focal point. As shown in FIG. 19B, the plasmon antenna 43 is formed from, for example, two triangular metal plates 43a composed of Au, and local plasmon resonance is excited at the ends 43at thereof.

Here, the spot size of the incident light is proportionate to a gap GP between the metal plates 43a. Therefore, the gap GP is determined in accordance with the size of a recording mark. For example, in the case where the recording particle 1S having a diameter D1 of about 20 nm is used and the information is recorded while one particle expresses 1 bit, this gap GP is set at about 20 nm which is nearly equal to the diameter D1.

This plasmon antenna 43 enhances the electric field at the ends 43at of the metal plates 43a and generates near field light LWn.

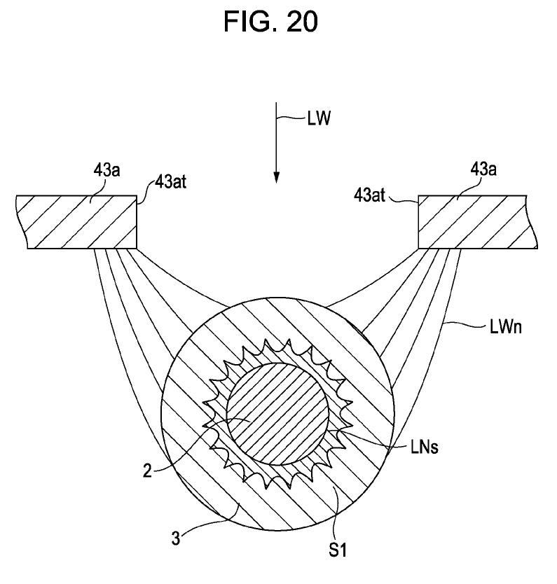

For example, as shown in FIG. 20, in the case where the information is recorded on the optical information recording medium 100, the plasmon antenna 43 generates near field light LWn in accordance with the recording light beam LW which is the incident light. Incidentally, in the drawing, the near field light LWn is expressed as an electric field.

Regarding the recording particle 1S, the nanoparticle 2 is coupled with the near field light LWn so as to produce local plasmon resonance. As a result, the recording particle 1S generates enhanced near field light LNs which is produced by further enhancing the electric field of the near field light LWn. Consequently, the recording particle 1S can raise the temperature of the medium 3 effectively, and the state of the medium 3 can be changed rapidly.

In the case where the medium 3 is a phase change material, for example, initialization light beam sufficient for the recording particle 1S to reach the crystallization temperature is applied, followed by cooling gradually, so that the media 3 of all recording particles 1S are crystallized (that is, initialized). Thereafter, in recording, the recording light beam LW is applied to the recording particles 1S which are desired to become amorphous. At this time, the light intensity of the recording light beam LW is specified to be lower than the initialization light beam, so that the media 3 of the recording particles 1S can remain in an unstable state and become amorphous. The crystalline/amorphous state of the recording particles 1S can be changed by a series of these operations, and the information can be recorded.

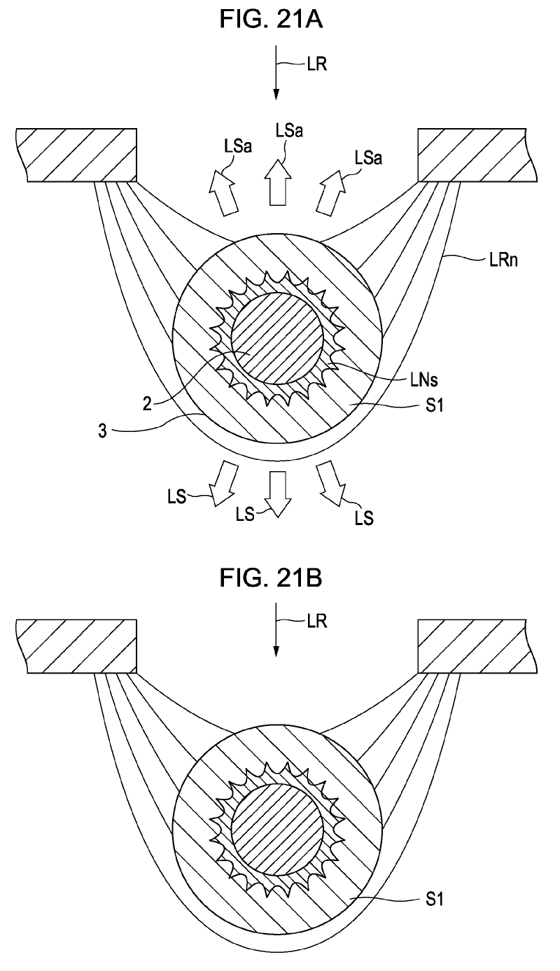

Furthermore, as shown in FIG. 21A, in the case where the information recorded on the optical information recording medium 100 is reproduced, the plasmon antenna 43 generates near field light LRn in accordance with the reproducing light beam LR which is the light incident into the recording particle 1S.

Regarding the recording particle 1S, in the case where the medium 3 is in the first state in which the degree of local plasmon resonance is large, the nanoparticle 2 is coupled with the near field light LRn so as to produce local plasmon resonance. As a result, the electric field is further enhanced and, thereby, enhanced near field light LNs is generated. At this time, as is explained with reference to FIG. 7, the recording particle 1S generates high intensity scattered light LS. Since this scattered light LS is generated in accordance with the high intensity near field light LRn, the light intensity thereof becomes very high.

Here, the spot forming portion 40 condenses the incident light with a large numerical aperture of 1 or more. Therefore, among the scattered light LS generated toward the spot forming portion 40, a wide angle of portion in accordance with the numerical aperture can be received as returned scattered light beam LSa.

As a result, regarding the optical pickup 30 (FIG. 17), high intensity returned scattered light beam LSa can be received by the light receiving element 36.

On the other hand, as shown in FIG. 21B, regarding the recording particle 1S, in the case where the medium 3 is in the second state in which the degree of local plasmon resonance is small, although the nanoparticle 2 is coupled with the near field light LRn, relatively low intensity scattered light LS is generated because the degree of local plasmon resonance is small.

As a result, regarding the optical pickup 30, low intensity returned scattered light beam LSa is received by the light receiving element 36. At this time, the optical pickup 30 can receive the returned scattered light beam LSa having the intensity higher than that of the reflected light reflected by the surface of the recording particle 1S, although the intensity is low as compared with that in the first state.

The optical information recording and reproducing apparatus 20 can reproduce the information on the basis of the high intensity returned scattered light beam LSa by producing the reproduction signal on the basis of the returned scattered light beam LSa on the light receiving element 36.

At this time, since the optical information recording and reproducing apparatus 20 can produce the reproduction signal on the basis of returned scattered light beam LSa exhibiting large difference in strength on the basis of the recorded information, the recorded information can be reproduced with high precision.

### (6) OPERATION AND EFFECT

In the above-described configuration, in the recording layer 101 of the optical information recording medium 100, nanoparticles 2 having diameters of 100 nm or less are disposed while being in the state of surrounded by the medium 3 having a complex dielectric constant ε2 which is changed in accordance with application of the near field light LWn on the basis of the recording light beam LW serving as light. Furthermore, regarding the optical information recording medium 100, the degree of local plasmon resonance produced by the nanoparticles 2 in accordance with changes in complex dielectric constant ε2 of the medium 3 is changed.

Consequently, the recording layer 101 can record the information through the use of differences in complex dielectric constant ε2 and, in addition, reproduce the information through the use of the degree of local plasmon resonance which is changed on the basis of differences in the complex dielectric constant ε2. As a result, the recording layer 101 can reproduce the information on the basis of the high intensity returned scattered light beam LSa generated by the local plasmon resonance.

Alternatively, the recording layer 101 has the configuration in which the recording particles 1S produced by enveloping the nanoparticle 2 in the medium 3 are arrayed. Consequently, regarding the recording layer 101, the thickness of the medium 3 relative to the nanoparticles 2 can be made uniform, and the degree of local plasmon resonance produced under the same condition can be made uniform on a nanoparticle 2 basis.

Here, as is described above with reference to FIG. 8, the electric field enhancement factor, that is, the degree of local plasmon resonance, is at the maximum when the diameter D2 of the nanoparticle 2 is 50 nm, and decreases gradually as the diameter D2 decreases. Here, it is believed that, for example, in order to achieve the recording density of 1 Tb/inch2, it is desirable that the usable area per bit is specified to be about 25 nm×25 nm.

Moreover, regarding the recording layer 101, one particle of the recording particle 1S expresses 1 bit of information. Therefore, the diameter D2 of the nanoparticle 2 can be set at the maximum as compared with that in the case where a plurality of recording particles 1S express 1 bit of information, so that local plasmon resonance can be produced efficiently.

In addition, regarding the recording layer 101, the recording particles 1S are arrayed only on the track on which the information is to be recorded. Consequently, the number of use of recording particles 1S of the recording layer 101 can be controlled at the minimum.

Furthermore, in the recording layer 101, adjacent recording particles 1S are arrayed separately from each other at predetermined intervals by arraying the recording particles 1S while positions are shifted in the radial direction on a track pitch TP basis and in the tangential direction on an interval SP basis.

Consequently, the recording particle 1S can almost exclude influences of enhanced near field light LWn and LRN from adjacent recording particles 1S, and crosstalk can be suppressed.

Alternatively, regarding the recording layer 101, the recording particles 1S are arrayed while being laid all over the recording layer 101. Consequently, a pattern of the track TR is not formed on the substrate 102 in advance and, thereby, the production process of the recording layer 101 can be simplified.

Moreover, regarding the recording layer 101, the medium 3 is formed from a phase change material which shifts to the crystalline state or the amorphous state in accordance with the application of the near field light LWn. Consequently, the recording layer 101 can be shifted to the crystalline state or the amorphous state again and again in accordance with the near field light LWn, and the optical information recording medium 100 can be used as a rewritable medium.

In addition, regarding the recording layer 101, Au, Ag, Pt, Al, or Cu is used as the nanoparticle 2. In general, it is in the public domain that these noble metals produce local plasmon resonance with respect to visible light. Consequently, the recording layer 101 can generate near field light LWn and LRn on the basis of the light which has a wavelength λ in the visible light region and which has track records in the use for BD, DVD, and CD.

Furthermore, regarding the recording layer 101, the diameter D2 of the nanoparticle 2 is 1 nm or more, and 50 nm or less. Therefore, as is shown in FIG. 8, local plasmon resonance can be produced efficiently while the nanoparticle 2 is in the stable state.

Moreover, regarding the recording layer 101, the thickness T3 of the medium 3 is 1 nm or more, and 25 nm or less. Therefore, as is shown in FIG. 9, local plasmon resonance can be produced efficiently.

In addition, the recording particle 1S has a diameter of 2 nm or more, and 52 nm or less. Therefore, the recording density of the optical information recording medium 100 can be improved while the recording particle 1S is in the stable state.

Here, in general, in the case where the plasmon antenna 43 is used, the recording light beam LW leaks from the periphery of the metal plates 43a and is applied to the recording layer 101. The optical information recording medium 100 includes the substrate 102 which is disposed adjoining the recording layer 101 and which passes the recording light beam LW serving as light at high transmittance. Consequently, the optical information recording medium 100 passes the leaked recording light beam LW and the light receiving element 36 does not receive the beam LW. Therefore, Excess light causing a noise is not included in the returned scattered light beam LSa, and the signal to noise (S/N) ratio of the reproduction signal can be improved.

Regarding the optical information recording medium 100, an antireflection film is disposed at an interface between the substrate 102 and the recording layer 101, so that reflection of the leaked recording light beam LW can be prevented and the S/N ratio of the reproduction signal can be further improved.

Furthermore, regarding the optical information recording and reproducing apparatus 20, the reading light beam LR emitted from the recording and reproducing light source 31 serving as a light source is condensed and applied to the optical information recording medium 100, and degree of local plasmon resonance produced in the optical information recording medium 100 is detected.

Consequently, the optical information recording and reproducing apparatus 20 can receive high intensity returned scattered light beam LSa generated by the local plasmon resonance and, in addition, the degree of the local plasmon resonance can be detected on the basis of a large difference in the amount of light of the scattered light beam LSa, so that the information can be reproduced with high precision.

Moreover, regarding the optical information recording and reproducing apparatus 20, the near field light LRn generated by the plasmon antenna 43 is applied to the optical information recording medium 100. Therefore, the near field light LRn having a small spot diameter and large energy can be applied.

In addition, regarding the optical information recording and reproducing apparatus 20, since the numerical aperture NA of the spot forming portion 40 as a whole serving as a light application portion is 1.0 or more, the scattered light LS generated from the nanoparticle 2 can be received at a large angle, and the amount of light of the returned scattered light beam LSa can be increased. Furthermore, since the spot forming portion 40 directly receives the scattered light LS generated from the nanoparticle 2, the scattered light LS is not attenuated, and the returned scattered light beam LSa having a large amount of light on the basis of the scattered light LS maintaining the large amount of the light can be obtained.

Moreover, regarding the optical information recording and reproducing apparatus 20, the recording light beam LW emitted from the recording and reproducing light source 31 is condensed and applied to the optical information recording medium 100 as the near field light LWn, and the intensity of the recording light beam LW is changed on the basis of the control of the control portion 2 in such a way that the degree of local plasmon resonance produced in the optical information recording medium 100 is changed.

Consequently, the optical information recording and reproducing apparatus 20 can record the information on the optical information recording medium 100 under the state in which a large returned scattered light beam LSa can be obtained.

According to the above-described configuration, the recording layer 101 of the optical information recording medium 100 is formed from the nanoparticles 2 having diameters of 100 nm or less and the medium 3, the information is recorded by changing the complex dielectric constant ε2 of the medium 3 in accordance with the application of the recording light beam LW, and the information is reproduced on the basis of changes in the degree of local plasmon resonance by the nanoparticle 2 in accordance with the application of the reading light beam LR.

Consequently, the optical information recording medium 100 can generate the returned scattered light beam LSa having a large amount of light as the returned light in reproduction of the information. In this manner, an optical information recording medium capable of increasing the amount of returned light, an information recording particle used for the optical information recording medium, and a method for reproducing optical information, an optical information reproducing apparatus, a method for recoding optical information, and an optical information recording apparatus, can be realized, in which the optical information recording medium is used.

### (7) OTHER EMBODIMENTS

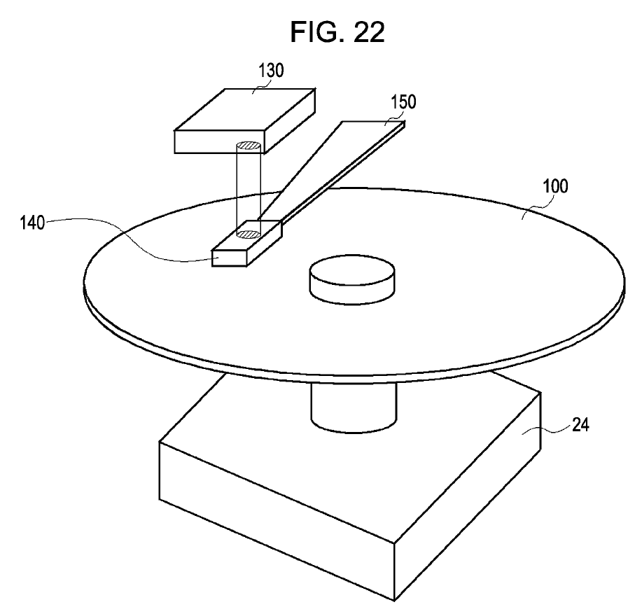

Incidentally, in the above-described embodiment, the case in which the optical pickup 30 is moved along the guide shafts 25A and 25B is described. However, the present application is not limited thereto. For example, as shown in FIG. 22, a suspension 150 which moves through rotation of a basal portion may be used. Regarding this suspension 150, a spot forming portion 140 is disposed at an end portion thereof and, in addition, an optical pickup 130 is disposed above the spot forming portion 140 in such a way that the optical pickup 130 is moved by a similar suspension (not shown in the drawing).

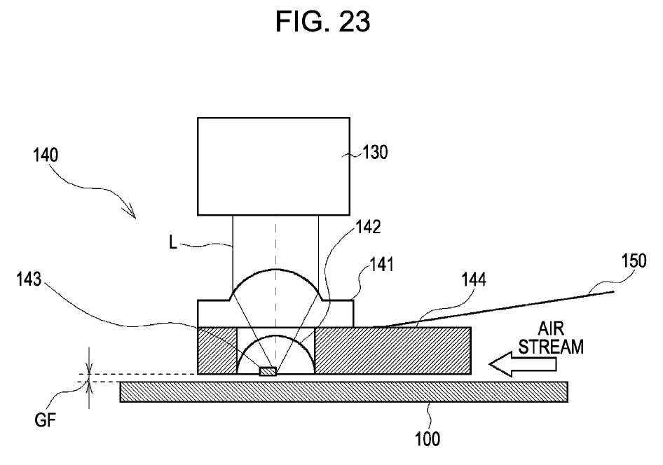

In this case, as shown in FIG. 23, the spot forming portion 140 receives and condenses incident light L incident from the optical pickup 130. At this time, the spot forming portion 140 is formed in a slider 144 which is moved by a pressure of the air while a predetermined floating clearance GF from an optical information recording medium 100 is maintained. As a matter of course, both optical pickup 130 and spot forming portion 140 may be disposed in the slider 144.

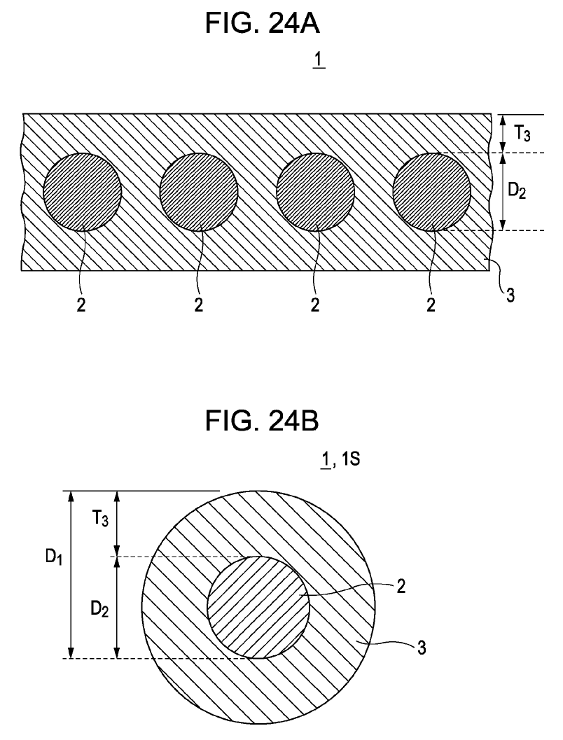

In the above-described embodiment, the case where metal particles are used as the nanoparticles 2 and a phase change material is used as the medium 3 is described. However, the present application is not limited thereto. For example, as shown in FIGS. 24A and 24B, a phase change material may be used as the nanoparticles 2 and metal particles may be used as the medium 3. Even in this case, local plasmon resonance can be produced at the interface between the nanoparticle 2 and the medium 3 on the basis of the polarization of the medium 3, and effects similar to those in the above-described embodiments can be obtained.

In the above-described embodiment, the case where the incident light L is condensed with the condenser lens 41, the solid immersion lens 42, and the plasmon antenna 43 and is applied to the optical information recording medium 100 is described. However, the present application is not limited thereto. In the present application, the incident light L can be condensed with optical components having various configurations and be applied to the optical information recording medium 100.

In the above-described embodiment, the case where the near field light LRn and LWn generated by the plasmon antenna 43 are applied to the optical information recording medium 100 is described. However, the present application is not limited thereto. For example, the light beam condensed by a simple condenser lens may be applied to the optical information recording medium 100.

In the above-described embodiment, the case where the scattered light LS moving in a direction reverse to the direction of the reproducing light beam LR is received as the returned scattered light beam LSa is described. However, the present application is not limited thereto. For example, the light receiving element may be disposed on the side opposite to the incident surface of the optical information recording medium 100 and receive the scattered light LS passed through the optical information recording medium 100. In this case as well, effects similar to those in the above-described embodiments can be obtained.

In the above-described embodiment, the case where the wavelength of the recording light beam LW and the reading light beam LR are specified to be the wavelength of the light at which the degree of local plasmon resonance becomes maximum is described. However, the present application is not limited thereto. In the present application, the wavelengths of the recording light beam LW and the reading light beam LR can be selected appropriately. For example, the recording light beam LW and the reading light beam LR with a wavelength of 405 nm may be used for the sample SS1 in Example 1.

In the above-described embodiment, the case where the recording layer 101 serving as a recording layer constitutes the optical information recording medium 100 serving as an optical information recording medium is described. However, the present application is not limited thereto. The optical information recording media may be formed from other recording layers 101 having various configurations.

In the above-described embodiment, the case where the recording particle 1S serving as a recording particle is formed from the nanoparticle 2 serving as a nanoparticle and the medium 3 serving as a medium is described. However, the present application is not limited thereto. The recording particles may be formed from other nanoparticles having various configurations and media.

In the above-described embodiment, the case where the optical information recording and reproducing apparatus 20 serving as an optical information reproducing apparatus is formed from the spot forming portion 40 serving as a light application portion and the light receiving element 36 serving as a detection portion is described. However, the present application is not limited thereto. The optical information reproducing apparatus according to an embodiment may be formed from other light application portions having various configurations and detection portions.

Furthermore, in the above-described embodiment, the case where the optical information recording and reproducing apparatus 20 serving as an optical information recording apparatus is formed from the spot forming portion 40 serving as a light application portion and the control portion 21 serving as a light intensity control portion is described. However, the present application is not limited thereto. The optical information recording apparatus according to an embodiment may be formed from other light application portions having various configurations and light intensity control portions.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. An optical information recording medium comprising:
a recording layer,
wherein nanoparticles having diameters of 100 nm or less are disposed while being surrounded by a medium having a complex dielectric constant which is changed in accordance with an application of light and
the degree of local plasmon resonance produced by the nanoparticles is changed in accordance with the change in the complex dielectric constant of the medium.

2. The optical information recording medium according to claim 1,
wherein the recording layer includes arrayed recording particles in which the nanoparticle is enveloped in the medium.

3. The optical information recording medium according to claim 2,
wherein one particle of the recording particles expresses 1 bit of information.

4. The optical information recording medium according to claim 2,
wherein the recording particles are arrayed only on the track, on which the information is to be recorded.

5. The optical information recording medium according to claim 2,
wherein the recording particles are arrayed separately from adjacent recording particles at predetermined intervals therebetween.

6. The optical information recording medium according to claim 2,
wherein the recording particles are arrayed while being laid all over the recording layer.

7. The optical information recording medium according to claim 1,
wherein the medium comprises a phase change material which shifts to a crystalline state or an amorphous state in accordance with the application of the light.

8. The optical information recording medium according to claim 1,
wherein the nanoparticle comprises Au, Ag, Pt, Al, or Cu.

9. The optical information recording medium according to claim 2,
wherein the recording particles have diameters of 3 nm or more, and 52 nm or less.

10. The optical information recording medium according to claim 2,
wherein the nanoparticles have diameters of 1 nm or more, and 50 nm or less.

11. The optical information recording medium according to claim 2,
wherein the medium has a thickness of 1 nm or more, and 25 nm or less.

12. The optical information recording medium according to claim 1, comprising a substrate which is disposed adjoining the recording layer and which passes the light at a high transmittance.

13. The optical information recording medium according to claim 12,
wherein the substrate comprises an antireflection film at an interface to the recording layer.

14. An optical information recording medium comprising:
a recording layer,
wherein metal fine particles having diameters of 100 nm or less are surrounded by a phase change material which shifts to a crystalline state or an amorphous state in accordance with an application of light.

15. An optical information recording medium comprising:
a recording layer
which is formed from nanoparticles having diameters of 100 nm or less and a medium,
on which information is recorded by changing the complex dielectric constant of the medium in accordance with an application of recording light, and
from which the information is reproduced on the basis of a change in degree of local plasmon resonance produced by the nanoparticles in accordance with an application of reading light.

16. A recording particle,
in which a nanoparticle having a diameter of 100 nm or less is enveloped in a medium having a complex dielectric constant which is changed in accordance with an application of light with a predetermined level of or higher intensity.

17. A recording particle comprising a nanoparticle having a diameter of 100 nm or less and a medium enveloping the nanoparticle,
wherein the complex dielectric constant of any one of the recording particle and the medium is changed in accordance with an application of light with a predetermined level of or higher intensity.

18. A method for reproducing optical information comprising the steps of:
condensing light and applying the light to an optical information recording medium; and
detecting the degree of local plasmon resonance produced in the optical information recording medium.

19. An optical information reproducing apparatus comprising:
a light application portion which condenses light emitted from a light source and applies the light to an optical information recording medium; and
a detection portion to detect the degree of local plasmon resonance produced in the optical information recording medium.

20. The optical information reproducing apparatus according to claim 19,
wherein the light application portion applies near field light generated from a plasmon antenna to the optical information recording medium.

21. The optical information reproducing apparatus according to claim 19,
wherein the light application portion has the numerical aperture (NA) of 1.0 or more on a whole light application portion basis.

22. A method for recoding optical information comprising:
recording information by changing the degree of local plasmon resonance produced in an optical information recording medium when light is applied to the optical information recording medium.

23. An optical information recording apparatus comprising:
a light application portion which condenses light emitted from a light source and applies the light to an optical information recording medium; and
a light intensity control portion to change the intensity of the light in such a way as to change the degree of local plasmon resonance produced in the optical information recording medium.
